(19) United States
(12) Patent Application Publication
(10) Pub. No.: US 2026/0073462 A1
(43) Pub. Date: Mar. 12, 2026

(54) METHODS AND APPARATUS FOR REDUCING COMPUTATIONAL LOAD FOR SCORING LEGAL SOURCE DOCUMENTS

(71) Applicant: ANALYTICA LEGALIS, INC., Scott Depot, WV (US)

(72) Inventors: Dylan Yingling, Scott Depot, WV (US); Warren F. Patterson II, Charleston, WV (US); Daniel Scarr, Uniontown, OH (US)

(21) Appl. No.: 18/830,193

(22) Filed: Sep. 10, 2024

(51) Int. Cl. G06Q 50/18

(52) U.S. Cl. CPC G06Q 50/18

(57) ABSTRACT

A method of reducing computational load for a jurisprudence scoring operation, includes accessing, by a computer system, a first-collected-opinion from a database having one or more collected-opinions, wherein the first-collected-opinion includes at least a non-dissenting portion and a dissenting portion, automatically generating, by the computer system, a dissent-identifying-index into the first-collected-opinion, wherein the dissent-identifying-index indicates a location within the first-collected-opinion that is associated with the start of the dissenting portion, initiating the jurisprudence scoring operation, by the computer system, on the first-collected-opinion, determining, by the computer system, whether the dissent-identifying-index has been reached, and stopping the jurisprudence scoring operation, by the computer system, based on a determination that the dissent-identifying-index has been reached. Preventing the jurisprudence operation from continuing past the dissent-identifying-index reduces the computational load of searching for string matches in the dissenting portion of the opinion thereby saving compute time and power consumption by the computer system.

### FIELD OF THE DISCLOSURE

Various illustrative embodiments disclosed herein relate to the analysis of legal documents and based thereon, providing guidance for the drafting of new documents.

### BACKGROUND

People working in many fields of endeavor may be called upon to write or speak in a generally persuasive manner. Those that practice in the legal profession are likewise often called upon to write or speak in a persuasive manner, but such writing or speech may need to be crafted in ways that are constrained by, or in some instances inspired by, prior legal writings, opinions, decisions or precedents. A number of manual and computer-based tools have been developed to assist lawyers in their search for the writings, opinions, decisions, precedents, and so on (collectively “writings”), that can support the legal arguments that they want to make.

### SUMMARY

In one illustrative embodiment, a method of reducing a computational load for a jurisprudence scoring operation is provided. The method may include accessing, by a computer system, a first-collected-opinion from a database having one or more collected-opinions, wherein the first-collected-opinion comprises text and includes at least a non-dissenting portion and a dissenting portion; automatically generating, by the computer system, a dissent-identifying-index into the first-collected-opinion, wherein the dissent-identifying-index indicates a location within the first-collected-opinion that is associated with the start of the dissenting portion of the first-collected-opinion; initiating the jurisprudence scoring operation, by the computer system, on the first-collected-opinion; determining, by the computer system, whether the dissent-identifying-index has been reached; and stopping the jurisprudence scoring operation, by the computer system, based on a determination that the dissent-identifying-index has been reached.

In some embodiments, further include initiating a tone scoring operation, by the computer system, on the first-collected-opinion, and initiating a sentiment scoring operation, by the computer system, on the first-collected-opinion.

In some embodiments, automatically generating a dissent-identifying-index into the first-collected-opinion includes providing a dissent-list, wherein the dissent-list includes a pre-determined set of dissent-indicating-text-segments; performing a first set of text matching operations, that includes comparing at least a portion of the set of the dissent-indicating text-segments to the text of the first-collected-opinion, identifying a location within the first-collected-opinion at which each text match occurs, and storing at least a portion of the identified locations; selecting a first one of the identified locations to be the dissent-identifying-index; and storing the dissent-identifying-index. The pre-determined set of dissent-indicating-text-segments may include one or more segments of text that are likely to be found in the language of a dissenting opinion. In various embodiments, the pre-determined set of dissent-indicating-text-segments may be updated, edited, or revised in any suitable manner.

In some embodiments, the jurisprudence scoring includes providing a category-list, wherein the category-list includes a plurality of categories; providing for each category of the plurality of categories, a corresponding set of category-score-indicating-text-segments; performing a second set of text matching operations that includes comparing at least a portion of each of the sets of category-score-indicating-text-segments to the non-dissenting portion of the first-collected-opinion, and counting the occurrences of text matches between each of the sets of category-score-indicating-text-segments and the non-dissenting portion of the first-collected-opinion, and storing a count of the occurrences for each of the sets of category-score-indicating-text-segments as a raw-score for each corresponding category; adding the raw-scores to generate a total count; providing, for each category of the plurality of categories, a corresponding predetermined scale factor; and scaling each raw score by its corresponding predetermined scale factor, wherein the category-list comprises at least one of a first term representing textualism, a second term representing traditionalism, a third term representing precedent, a fourth term representing policy, a fifth term representing purposivism, and a sixth term representing originalism.

In some embodiments, scaling the raw score for each corresponding category includes performing a floating point multiplication between at least a first raw-score and a corresponding predetermined scale factor to generate a first scaled score.

In some embodiments, the method further includes performing a floating point division of at least the first scaled score by 100; and rounding a result of the floating point division.

In some embodiments, accessing the first-collected-opinion from the database having one or more collected-opinions includes receiving at least one date range for an adjustable time filter; and prohibiting access to collected-opinions having dates that are outside the at least one date range.

In some embodiments, the dissent-list includes one or more of the phrases: “I dissent,” “It is so ordered,” “The judgment of the Court of Appeals is reversed, and the case is remanded for further proceedings consistent with this opinion,” “join, dissenting,” “requiring this respectful dissent,”“It is so ordered,”and “Judgment reversed”.

In some embodiments, the set of category-score-indicating-text-segments for the textualist category includes one or more of the phrases: “plain text,” “statutory text,” “plain term,” “plain terms,” “ordinary meaning,” “plain meaning,” “natural meaning,” and “ordinary reading”.

In some embodiments, the method further includes modifying, by the computer system, at least one predetermined scale factor responsive to an input received by the computer system.

In another illustrative embodiment, a method of reducing a computational load for a scoring operation includes receiving, by a computer system, at least one date range for an adjustable time filter; accessing, by the computer system, a first-collected-opinion from a data storage resource having one or more collected-opinions, wherein the first-collected-opinion comprises text and includes at least a non-dissenting portion and a dissenting portion; automatically generating, by the computer system, a dissent-identifying-index into the first-collected-opinion, wherein the dissent-identifying-index indicates a location within the first-collected-opinion that is associated with the start of a dissenting portion of the first-collected-opinion; generating a workload-reduced-first-collected-opinion from the first-collected-opinion, wherein the workload-reduced-first-collected-opinion does not include the dissenting portion of the first-collected-opinion; and wherein accessing the first-collected-opinion from the database having one or more collected-opinions includes prohibiting access to collected-opinions having dates that are outside the at least one date range of the adjustable time filter.

In some embodiments, the method further includes storing the workload-reduced-first-collected-opinion to the data storage resource.

In some embodiments, the method further includes providing a category-list, wherein the category-list includes a plurality of categories; and providing for each category of the plurality of categories, a corresponding set of category-score-indicating-text-segments.

In some embodiments, the category-list includes at least one of a first term representing textualism, a second term representing traditionalism, a third term representing precedent, a fourth term representing policy, a fifth term representing purposivism, and a sixth term representing originalism.

In some embodiments, the category-list comprises at least one of a first term representing agreeableness, a second term representing antagonistic, a third term representing formal, a fourth term representing informal, a fifth term representing eccentricity, and a sixth term representing stoicism.

In some embodiments, the category-list comprises at least one of a first term representing positive, a second term representing negative, a third term representing openness, a fourth term representing obstinance, a fifth term representing empathy, and a sixth term representing detachment.

In a further illustrative embodiment, a system for reducing the computational load of analyzing legal documents includes a non-transitory memory having computer instructions stored therein that when executed by a computer system cause the computer system to: access a first-collected-opinion from a database having one or more collected-opinions, wherein the first-collected-opinion comprises text and includes at least a non-dissenting portion and a dissenting portion; automatically generate a dissent-identifying-index into the first-collected-opinion, wherein the dissent-identifying-index indicates a location within the first-collected-opinion that is associated with the start of the dissenting portion of the first-collected-opinion; initiate a scoring operation on the first-collected-opinion; determine whether the dissent-identifying-index has been reached; and stop the scoring operation based on a determination that the dissent-identifying-index has been reached.

In some embodiments, the scoring operation includes one or more of jurisprudence scoring, tone scoring, and sentiment scoring.

In some embodiments, the non-transitory memory has further computer instructions stored therein that when executed by the computer system cause the computer system to: provide a category-list, wherein the category-list includes a plurality of categories; provide for each category of the plurality of categories, a corresponding set of category-score-indicating-text-segments; perform a set of text matching operations that include comparing at least a portion of each of the sets of category-score-indicating-text-segments to the non-dissenting portion of the first-collected-opinion, and counting the occurrences of text matches between each of the sets of category-score-indicating-text-segments and the non-dissenting portion of the first-collected-opinion, and storing a count of the occurrences for each of the sets of category-score-indicating-text-segments as a raw-score for each corresponding category; add the raw-scores to generate a total count; provide, for each category of the plurality of categories, a corresponding predetermined scale factor; and scale each raw score by its corresponding predetermined scale factor.

In some embodiments, the category-list includes at least one of a first term representing textualism, a second term representing traditionalism, a third term representing precedent, a fourth term representing policy, a fifth term representing purposivism, and a sixth term representing originalism.

In some embodiments, the system further comprises an adjustable time filter.

The foregoing has outlined rather broadly the features of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1A is a high-level block diagram of a system in accordance with this disclosure.

FIG. 1B is a sequence diagram of an illustrative method in accordance with this disclosure.

FIG. 2 is a high-level flow diagram of an illustrative method in accordance with this disclosure.

FIG. 3 is a flow diagram of an illustrative method of opinion collection, in accordance with this disclosure

FIG. 4A is a flow diagram of an illustrative method of jurisprudence scoring, in accordance with this disclosure.

FIG. 4B is a flow diagram of an alternative illustrative method of jurisprudence scoring, in accordance with this disclosure.

FIG. 5 is a flow diagram of an illustrative method of tone scoring, in accordance with this disclosure.

FIG. 6 is a flow diagram of an illustrative method of sentiment scoring, in accordance with this disclosure.

FIG. 7 is a flow diagram of an illustrative method of performing jurisprudence scoring, tone scoring, and sentiment scoring in parallel, in accordance with this disclosure.

FIG. 8 is a flow diagram of an illustrative method of brief scoring, in accordance with this disclosure.

FIG. 9 is a flow diagram of an illustrative method of re-writing a portion of a brief, in accordance with this disclosure.

FIG. 10 is a high-level block diagram of a computer system in accordance with this disclosure.

### DETAILED DESCRIPTION

Various embodiments, in accordance with this disclosure, may provide a suite of tools and methods that may be used over a range of use cases for assisting at least legal professionals to prepare their briefs such that those briefs have an improved likelihood of persuading a decision-maker to decide a case in favor of the position presented in the brief.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of embodiments in accordance with this disclosure will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

People working in many fields of endeavor may be called upon to write or speak in a generally persuasive manner. Those that practice in the legal profession are likewise often called upon to write or speak in a persuasive manner, but such writing or speech may need to be crafted in ways that are constrained by, or in some instances inspired by, prior legal writings, opinions, decisions or precedents. A number of manual and computer-based tools have been developed to assist lawyers in their search for the writings, opinions, decisions, precedents, and so on (collectively “writings”), that can support the legal arguments that they want to make. However, there is a need to, as quickly as possible, make a lawyer's arguments as effective and persuasive as possible. In order to address this need, the tools should direct lawyers to not just writings that support the legal arguments that they intend to make, but to those writings that also illuminate the most effective way to convince or persuade the particular decision maker to whom the lawyer's arguments are to be presented.

Various embodiments in accordance with this disclosure provide methods and apparatus for assisting lawyers in their search not just for writings that support the legal arguments that they intend to make, but also to those writings that illuminate effective ways to convince or persuade the particular decision-maker(s) to whom the lawyer's arguments are to be presented. These arguments are often presented in the form of a brief (which is described in greater detail below).

As described in greater detail below, apparatus, systems, and methods in accordance with this disclosure may obtain briefs previously submitted to a court, or similar adjudicative entity, analyze those briefs, and store the briefs along with the results of the analysis in a data storage system or database. Similarly, apparatus, systems, and methods in accordance with this disclosure may obtain opinions previously issued by a court, or similar adjudicative entity, analyze those opinions, and store the opinions along with the results of the analysis in a data storage system or database. Further, apparatus, systems, and methods in accordance with this disclosure may obtain draft-briefs prior to filing with a court, or similar adjudicative entity, analyze those draft-briefs, and compare the results of the draft-brief analysis with the results of the analysis of previously submitted briefs or the results of the analysis of previously issued opinions.

In some embodiments, consistent with but not necessarily required by various implementations in accordance with this disclosure, a data storage resource or database may be provided to store, among other things, previously collected opinions and/or briefs, where those opinions have been issued and those briefs that have been submitted to various adjudicative entities or decision-makers. It is noted that both some of the submitted briefs and some of the issued opinions that are collected, analyzed, and stored, may deal with issues that are not related directly or indirectly to a draft-brief that is to be analyzed and scored. Likewise, some of the submitted briefs and some of the issued opinions that are collected, analyzed, and stored, may be associated with judges or decision-makers that are not involved with a case to which the draft-brief that is to be analyzed and scored may be directed. However, in such a scenario, various embodiments in accordance with this disclosure may select the collected, analyzed, and stored briefs or opinions that are relevant to the subject matter of, or decision-maker associated with, the draft-brief. By removing unrelated briefs and opinions from the comparison with the draft-brief, the results of the comparison of may provide useful and actionable information for revising the draft-brief so as to be potentially more persuasive to the appropriate judge or decision-maker. Unless otherwise noted, as used herein the term “decision-maker”includes judge.

Since various embodiments, in accordance with this disclosure, may analyze and score previously submitted briefs, issued opinions, and unfiled draft-briefs, there are a number of ways that such capabilities may be used. By way of example and not limitation, in one use case, for a given draft-brief that argues for a particular legal outcome by a particular decision-maker, analytical information may be provided by the embodiments based on previously submitted briefs that were successful in obtaining that legal outcome (or possibly a similar legal outcome) before that particular decision-maker. Likewise, in another use case, for a given draft-brief that argues for a particular legal outcome by a particular decision-maker, analytical information may be provided by the embodiments based on issued opinions by the particular decision-maker that support the desired legal outcome of the draft-brief. In various embodiments the analytical information may include, but is not limited to argument-type-scores. As explained in greater detail below, argument-type-scores in accordance with this disclosure may provide guidance to the authors of the draft-brief in terms of revising their argument styles and approaches in order to make their written work product more persuasive to the decision-maker.

Legal professionals typically prepare a draft of their brief for review and revision prior to submitting the brief. This draft may be referred to herein as a draft-brief. In order to improve the likelihood of persuading a decision-maker to decide in favor of the position presented in the brief that is finally submitted, various embodiments may be used to analyze the draft-brief, determine various characteristics or parameters of the draft-brief and report those results to, for example, the author(s) of the draft-brief. Further, various embodiments may compare the characteristics or parameters of the draft-brief with the characteristics or parameters of other briefs that have been presented to the same decision-maker(s) and which have resulted in favorable legal outcomes, and communicate the findings of the comparison to the author(s) of the draft-brief. Still further, various embodiments may compare the characteristics or parameters of the draft-brief with the characteristics or parameters of opinions by the target decision-maker(s) that support the legal outcome desired by the author(s) of the draft brief.

As set forth above, some embodiments, in accordance with this disclosure, may perform at least one or more of the following: (i) analyze a draft-brief and report the results of the analysis; (ii) analyze the draft-brief, analyze briefs previously submitted to a target decision-maker, wherein those previously submitted briefs are associated with a legal outcome that is the same as or similar to the legal outcome sought by the draft-brief, compare these analyses and identify where and how the draft-brief differs from those previously submitted briefs; and (iii) analyze the draft-brief, analyze opinions previously written by a target decision-maker, wherein those previously written opinions are associated with a legal outcome that is the same as or similar to the legal outcome sought by the draft-brief, compare these analyses and identify where and how the draft-brief differs from those previously written opinions.

A brief is a written document that establishes an argument and explains why a governing body, or an adjudicative body such as but not limited to a court, should make a decision based, for example, on precedent—i.e., the holdings of prior decisions, regulations, and statutory law. It is noted that are categories of persuasion other than precedent that may be used to persuade decision-makers, such as judges, to adopt the position of the brief author. Typically, a legal brief is submitted to a court or decision-maker, and presents arguments as to why one party to a particular case should prevail over an opposing party. There are numerous types of legal briefs including pre-trial briefs, trial briefs, amicus briefs, and appellate briefs, to name but a few.

A brief is intended to appeal to the decision-maker and their understanding of legal precedent and, when appropriate, public policy and social customs. The party filing the legal brief is attempting to convince the decision-maker to ultimately see a situation their way and make a decision favorable to that party.

In some cases, a court may decide a case based on the submitted legal briefs without oral argument. Thus, these briefs may be critical to the outcome of any decision. Therefore, to achieve the goal of persuading a decision-maker, these briefs should be carefully crafted with language that appeals to the decision-maker's governing philosophy and social beliefs.

Lawyers and their assistants spend enormous amounts of time studying, not only the law, but also the publicly available information about the decision-maker and the decision-maker's prior decisions and current beliefs. This information may be available in prior writings of the decision-maker, such as written decisions or previously filed briefs. These documents include the use of certain words, phrases, or argument types which may be analyzed. The usage and corresponding success rates may illustrate how and why a decision-maker could be persuaded into making a favorable decision in a future case.

Various embodiments in accordance with this disclosure may assist lawyers and their assistants with research and analysis in an effort to increase or maximize the persuasiveness of an argument by informing a user of one or more strategies or approaches to successfully appealing to the governing philosophy and social beliefs of the decision-maker. Various embodiments in accordance with the present disclosure may achieve this, at least in part, by searching for, retrieving, and analyzing the published writings of a decision-maker together with other related published writings, if any.

In some embodiments, the use of certain words, phrases, and argument types are analyzed from published documents to create argument type scores. Some embodiments in accordance with this disclosure compare a draft-brief to previously successful briefs and generate a user-readable output, such as but not limited to, a chart comparing scores. In other embodiments, multi-dimensional visualization data objects may be synthesized and stored in memory for subsequent high-bandwidth presentation. In at least this way, various embodiments rapidly communicate insight into the likelihood of success for various arguments being considered by the drafters of legal briefs.

Various embodiments in accordance with this disclosure may alternatively determine what arguments were consistent failures with particular decision-makers.

Various embodiments in accordance with this disclosure may save a user time, effort, and resources in the preparation of a legal brief, while increasing the likelihood of achieving a successful outcome in a legal proceeding in which the legal brief is to be submitted. Various embodiments in accordance with this disclosure may be used not only by the legal community, but also by anyone who needs a favorable decision to achieve an outcome from a judge, commission, board, review panel, arbitrator, or other governing or adjudicating body.

Various embodiments in accordance with the present disclosure may be built in numerous ways which vary in different aspects and features to achieve different results for legal professionals and others who are making arguments before decision-makers in different situations. The illustrative outputs may also be tailored to the needs of specific users.

Various embodiments that provide a jurisprudence and legal brief analyzer with data visualization output functionality may use, but are not limited to, R, Python, Python code libraries, SQL, Golang, and/or other computer programming languages and software, individually or in concert, to mine text, research, analyze, and make comparisons to determine the usage frequency and results of using certain words, phrases, or arguments. R is a programming language for statistical computing and data visualization (see The R Project for Statistical Computing, www. r-project. org). Python is an interpreted, object-oriented, high-level programming language with dynamic semantics, and high-level built-in data structures (see python, www. python. org). Python code libraries are collections of pre-written code and functions that extend the capabilities of the Python programming language. There are thousands of available Python code libraries. (Some examples of Python code libraries include, but are not limited to, Matplotlib, Seaborn and, Ggplot.) SQL is the Structured Query Language and is commonly used for database creation and manipulation. SQL queries can be used to, among other things, quickly retrieve data from a database. Golang, also referred to as the Go programming language, has many applications including but not limited to developing web services, or processing and analyzing large datasets.

In various illustrative embodiments in accordance with this disclosure, a legal brief analyzer is provided. In some embodiments, the legal brief analyzer functions such that legal terms of art are found in the draft-brief, and those legal terms of art are matched to certain types of legal arguments.

In some embodiments, an artificial intelligence (AI) system sifts through previously submitted briefs that have succeeded before a given judge or decision-maker and are analyzed to create average argument type scores for the previously submitted briefs from within a predetermined time frame, wherein the predetermined time frame may be set by an adjustable time filtration feature. The functionality of the AI system may be implemented using, for example, R, Python, Python code libraries, and/or other computer programming languages and/or software, individually or in concert. In some embodiments, the adjustable time filtration feature may be included to increase accuracy by eliminating outdated ideas and concepts. The AI system also sifts through a specific submitted brief to detect the argument types.

Various embodiments may communicate the results of the comparisons, by producing charts, graphs, or data visualizations. In some embodiments, a similar comparison may be made between the argument type scores of a draft-brief and the argument type scores of previously submitted unsuccessful briefs. This information may then be used to improve the draft-brief or argument to increase the likelihood of success before a particular decision-maker.

Legal brief data may be drawn from a legal-information-source via a network such as, for example, the internet. The legal brief data obtained via the network, may then be stored in a data-storage resource. The legal brief data from a first legal-information-source is run through a legal-analytics-process, then legal brief data from a second legal-information-source is run through the legal-analytics-process. In some embodiments, the second legal-information-source may be, but is not required to be, a user's computer that transmits a draft-brief to the system to be run through the legal-analytics-process. The legal-analytics-process may include extracting text from documents, cleaning the text to correct anomalies, detecting variables within the text, and applying research methodologies based on the variables detected. The results, e.g., argument type scores, from the legal-analytics-process may then be used to create data visualizations.

Various embodiments, in accordance with the present disclosure, may use the argument type scores, as well as use of R, Python, Python code libraries, and/or other computer programming languages and software, individually or in concert, and the analysis of briefs to produce prescriptive analytics based on empirical evidence. Natural language processing, sentiment analysis, and other forms of machine learning/artificial intelligence might be used in different embodiments. At the end of the process, embodiments in accordance with the present disclosure may produce a graphic output, or a data visualization output, either of which may be tailored to the individual needs of a user.

In some embodiments, a jurisprudence-analytics feature uses a process, similar but not identical to the process described above, but instead of briefs, it analyzes opinions written by judges over a certain time period to produce an average argument type score. Users preparing for oral argument before a decision-maker may better predict receptiveness of such a decision-maker to certain arguments through the use of the jurisprudence-analytics feature found in various embodiments in accordance with this disclosure.

In an illustrative embodiment of the jurisprudence-analytics feature, legal opinion data is drawn from a legal-information-source via a network, such as for example the internet. The legal opinion data may be stored in a data-storage resource. The legal opinion data from the legal-information-source is run through the legal-analytics-process. The legal-analytics-process involves extracting text from documents, cleaning the text to correct anomalies, detecting variables within the text, and applying research methodologies based on the variables detected. The results from the legal-analytics-process may then be used to create data visualizations.

The jurisprudence-analytics feature, using empirical evidence obtained from the legal-analytics-process, may assess the jurisprudential leanings of a decision-maker and then use that information to help lawyers, among other uses, prepare for oral argument. The legal-analytics-process with the jurisprudence-analytics feature is configured to produce illustrated data visualizations for communication with a user. The user may also request charts or graphs in addition to the data visualizations.

Some embodiments, in accordance with this disclosure, may include a fatal-language-finder feature. The fatal-language-finder feature performs a process similar to that performed during the jurisprudence analysis process, but draws data from three sources of information.

Authors of draft-briefs may study the results produced by the fatal-language-finder in order to better predict how a decision-maker would react to the draft-brief. The fatal-language-finder feature is configured to spot terms in legal documents (contracts, wills, etc.) that also appear in court cases as language that was ambiguous, illusory, or otherwise troublesome and resulted in unwanted legal action. The fatal-language-finder feature then produces an automated response alerting the authors of the draft-brief to that similarity and may further provide a citation to the relevant case. Based, at least in part, on their study of the results produced by the fatal-language-finder, the authors of the draft-brief may modify their draft-brief accordingly to improve the probability of success.

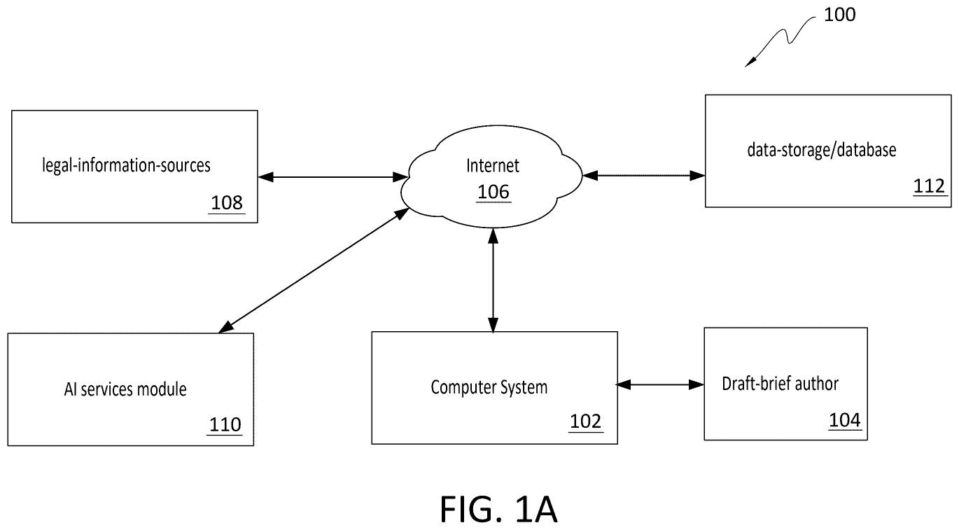

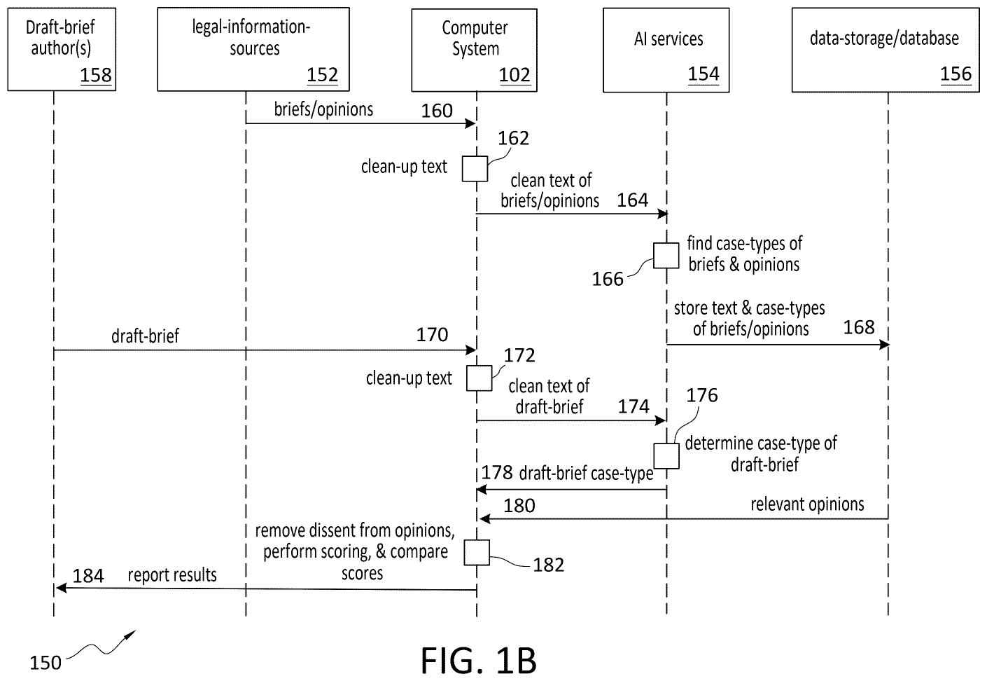

FIG. 1A illustrates a system 100 in accordance with this disclosure. System 100 includes a computer system 102, a draft-brief author 104, a communications network 106, one or more legal-information-sources 108, and an AI services module 110. In system 100, computer system 102 may be any suitable computer system and is not limited to any particular architecture or operating system. Draft-brief author 104 is coupled to computer system 102, and may be any suitable interface through which information related to a draft-brief may be communicated to or from computer system 102. Computer system 102 is coupled to a communications network such as but not limited to internet 106. One or more legal-information-sources 108 are coupled via internet 106 to computer system 102. AI services module 110 is coupled via internet 106 to computer system 102. Data storage resource/database 112 is coupled via internet 106 to computer system 102.

Still referring to FIG. 1A, legal-information-sources 108 may be any on-line source of court documents such as previously submitted briefs and issued opinions. Legal-information-sources 108 may further include documents from other adjudicatory or regulatory entities. AI services module 110 may be provided by an AI services provider that is remote from the location of computer system 102. By way of example and not limitation, AWS (Amazon Web Services) provides a variety of AI infrastructure and services that can be accessed via the internet. It is noted that alternative embodiments may include an AI services module within computer system 102. Data storage/database 112 provides storage and related services for data generated by system 100, such as but not limited to, cleaned versions of previously submitted briefs obtained by system 100, cleaned versions of issued opinions obtained by system 100, and cleaned versions draft-briefs submitted for analysis to system 100, together with various analytics, metadata, bibliographic data and so on that is related to the stored briefs and opinions that have been collected by system 100. As shown in FIG. 1A, data storage/database 112 is remotely located from computer system 102, and may be provided by an external services provider such as a cloud storage provider. By way of example and not limitation, the cloud storage for implementing remotely-located data storage/database 112 may be provided by AWS, such as by the AWS S3 cloud storage service. In an alternative embodiment, data storage/database 112 may be co-located with computer system 102.

FIG. 1B is a sequence diagram of an illustrative method 150 in accordance with this disclosure. Method 150 includes interactions between computer system 102, legal-information-sources 152, AI services module 154, data storage resource 156, and a user interface to receive input from and provide output to one or more draft-brief authors. Method 150 includes downloading 160 briefs and opinions from legal-information-sources 152 to computer system 102. Computer system 102 may then clean-up 162 the text of the downloaded briefs and opinions. Clean-up 162 may include any suitable form of text pre-processing that would make subsequent processing steps more accurate or efficient, such as, but not limited to, removing hyphens. The cleaned up text of the downloaded brief and opinions are transferred 164 to AI services module 154. AI services module 154 may be software running on computer system 102, or software running on a different computer co-located with computer system 102, or it may be a combination of hardware and software, remote from computer system 102 and made available by an AI services provider.

AI services module 154 analyzes the briefs and opinions that it received from computer system 102 and determines a case-type for each of those legal documents. The briefs and opinions along with their identified case-types are stored 168 to data storage resource 156.

Still referring to FIG. 1B, a draft-brief is transmitted 170 from user interface 158 to computer system 102. The text of the draft-brief may be cleaned up 172 by computer system 102. The clean text of the draft-brief is then transferred 174 to AI services module 154. AI services module 154 may determine 176 the case-type of the draft-brief and return 178 that information to computer system 102. At the request of computer system 102, data storage resource 156 transmits 180 a set of relevant opinions to computer system 102. In some embodiments, opinions are relevant if they have, for example, a matching case-type of draft-brief, a desired date range of opinions, a requested judge, or a requested court.

Still referring to FIG. 1B, method 150 performs scoring 182 operations on the non-dissenting portions of the relevant opinions, averages those scores, and compares those average scores to the scoring of the draft-brief. The results of the scoring comparisons reported 184 via the user interface 158.

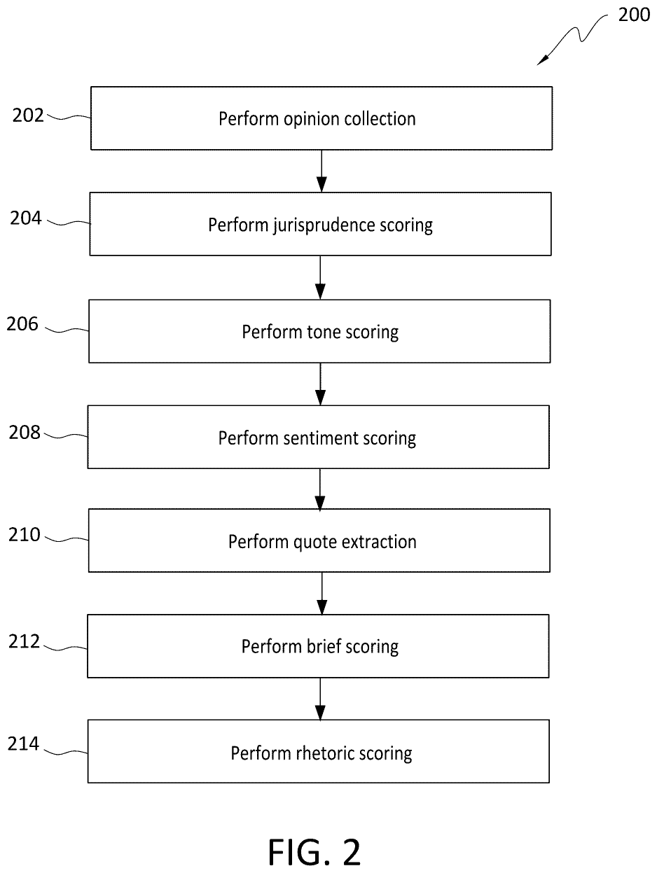

FIG. 2 is a high-level flow diagram of an illustrative method 200 in accordance with this disclosure. Method 200 includes performing 202 one or more opinion collection operations. Method 200 continues by performing 204 one or more jurisprudence operations, performing 206 one or more tone scoring operations, performing 208 one or more sentiment scoring operations, performing 210 one or more quote extraction operations, performing 212 one or more brief scoring operations, and performing 214 one or more rhetoric scoring operations.

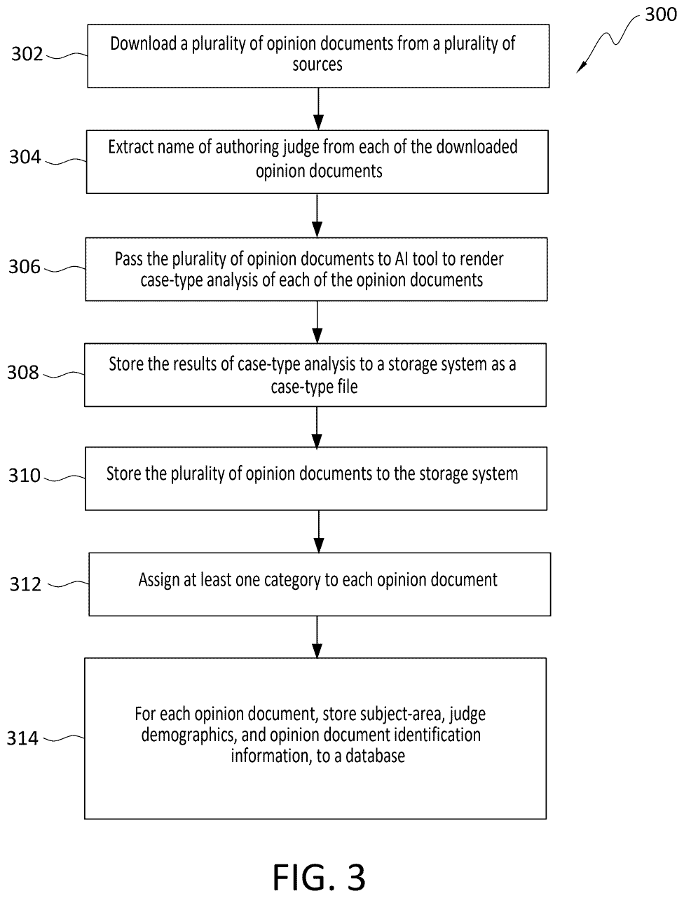

FIG. 3 is a flow diagram of an illustrative method 300 of opinion collection, in accordance with this disclosure. Method 300 includes downloading 302, by a computer system, a plurality of opinion documents from a plurality of sources. By way of example and not limitation, downloading court opinions via the internet from the websites of various courts. Method 300 continues by extracting 304 the name of the authoring judge from each of the downloaded opinion documents. Method 300 may further include passing 306 the opinion documents to an AI tool to render case-type analysis of each of the opinion documents. Such an AI tool may be running on the computer system, running on a different computer that is co-located with the computer system, or running on a cloud-based system. In some instances, cloud-based AI tools may be accessible through third-party service providers. Method 300 may include storing 308 the results of case-type analysis to a storage system as a case-type file, and storing 310 the plurality of opinion document to the storage system Method 300 further includes assigning 312 at least one category to each opinion document, and for each opinion document, storing 314 the subject area of downloaded opinion, judge demographics, and opinion document identification information, to the storage system, or to a database associated with the storage system.

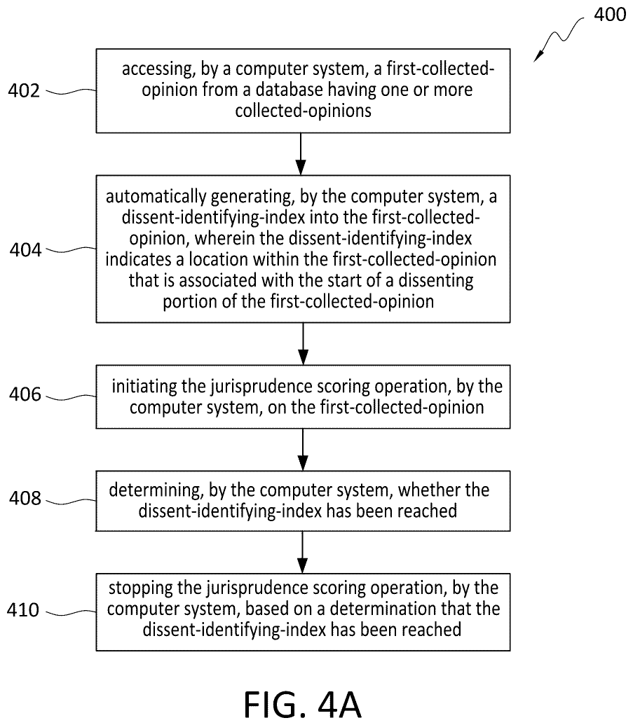

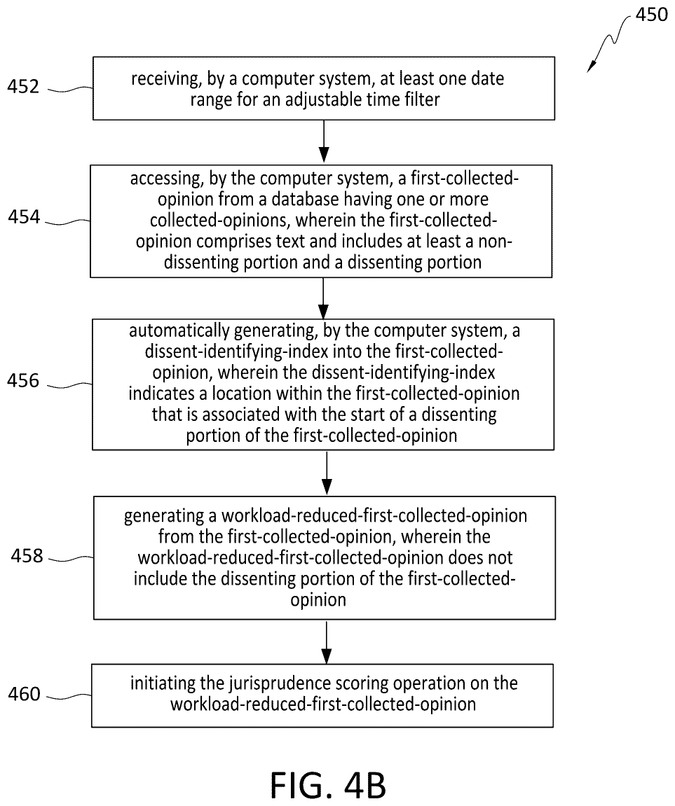

FIG. 4A is a flow diagram of an illustrative method 400 of jurisprudence scoring, in accordance with this disclosure. Method 400 includes accessing 402, by a computer system, a first-collected-opinion from a database having one or more collected-opinions. In various embodiments, prior to accessing the first-collected-opinion, one or more opinions are obtained from various sources of legal information, subjected to various text cleaning operations, subjected to various AI analyses, and stored by a data storage resource. The opinions that are stored in this way are referred to herein as “collected-opinions.” As used herein, “first-collected-opinion” refers to one of one or more collected-opinions.

Method 400 continues by automatically generating 404, by the computer system, a dissent-identifying-index into the first-collected-opinion, wherein the dissent-identifying-index indicates a location within the first-collected-opinion that is associated with the start of a dissenting portion of the first-collected-opinion. Generating 404 the dissent-identifying-index may include performing one or more string searches of the first-collected-opinion to identify one or more strings that indicate the beginning of a dissent portion of the first-collected-opinion.

Still referring to FIG. 4A, method 400 further includes initiating 406 the jurisprudence scoring operation on the first-collected-opinion, determining 408 whether the dissent-identifying-index has been reached, and stopping 410 the jurisprudence scoring operation based on a determination that the dissent-identifying-index has been reached. By interrupting the jurisprudence scoring operation before the text of the dissenting portion of the first-collected-opinion is scored provides improvements to the operation of the computer system, and further provides greater fidelity to the results of the jurisprudence scoring. Since the computational load of performing jurisprudence scoring on the whole text of the first-collected-opinion is reduced by causing the computer system to skip over the dissenting-portion of the first-collected-opinion, there is a corresponding beneficial reduction in compute time and power consumption. Moreover, the dissenting-portion contains words, phrases, sentences, and ideas that do not represent the majority's principles, reasoning, and holding of the first-collected-opinion. Thus, because the jurisprudence scoring of method 400, in accordance with this disclosure, is able to avoid counting words and phrases found in the dissenting-portion, the results of the jurisprudence scoring operation more accurately represent the majority opinion in the first-collected-opinion.

FIG. 4B is a flow diagram of another illustrative method 450 of jurisprudence scoring, in accordance with this disclosure. Method 450 includes receiving 452, by a computer system, at least one date range for an adjustable time filter, and accessing 454, by the computer system, a first-collected-opinion from a database having one or more collected-opinions, wherein the first-collected-opinion comprises text and includes at least a non-dissenting portion and a dissenting portion. The adjustable time filter may be implemented as a memory locations or hardware registers of the computer system that store the information that specifies the at least one date range.

Method 450 continues by automatically generating 456, by the computer system, a dissent-identifying-index into the first-collected-opinion, wherein the dissent-identifying-index indicates a location within the first-collected-opinion that is associated with the start of a dissenting portion of the first-collected-opinion, and by generating 458, a workload-reduced-first-collected-opinion from the first-collected-opinion, wherein the workload-reduced-first-collected-opinion does not include the dissenting portion of the first-collected-opinion. That is, the workload-reduced-first-collected-opinion contains the non-dissenting portion and does not contain the dissenting portion of the first-collected-opinion. Method 450 further includes initiating 460 the jurisprudence scoring operation on the workload-reduced-first-collected-opinion.

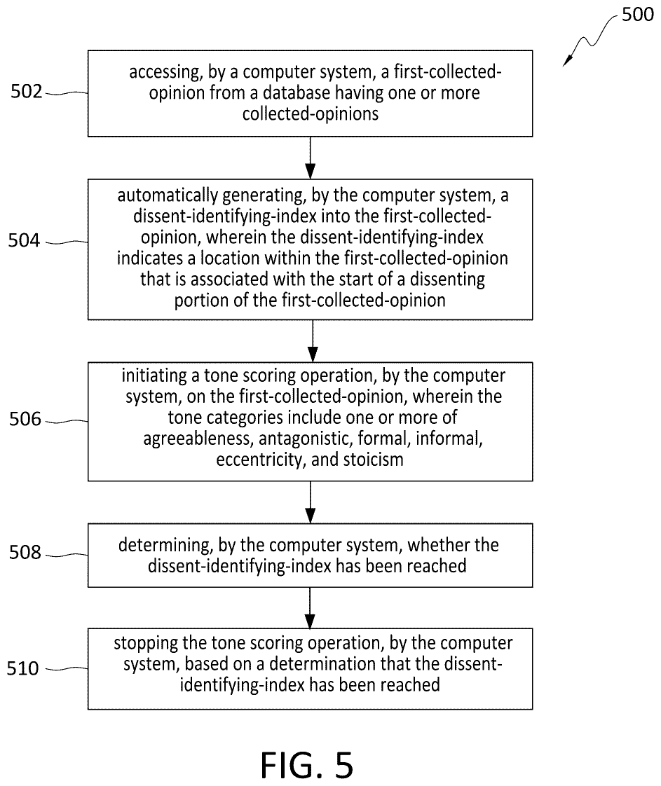

FIG. 5 is a flow diagram of an illustrative method 500 of tone scoring, in accordance with this disclosure. Method 500 is similar to method 400 but differs in the categories that are evaluated. Method 500 includes accessing 502, by a computer system, a first-collected-opinion from a database having one or more collected-opinions. In various embodiments, prior to accessing the first-collected-opinion, one or more opinions are obtained from various sources of legal information, subjected to various text cleaning operations, subjected to various AI analyses, and stored by a data storage resource.

Method 500 continues by automatically generating 504, by the computer system, a dissent-identifying-index into the first-collected-opinion, wherein the dissent-identifying-index indicates a location within the first-collected-opinion that is associated with the start of a dissenting portion of the first-collected-opinion. Generating 504 the dissent-identifying-index may include performing one or more string searches of the first-collected-opinion to identify one or more strings that indicate the beginning of a dissent portion of the first-collected-opinion.

Still referring to FIG. 5, method 500 further includes initiating 506 the tone scoring operation on the first-collected-opinion, wherein the tone categories include one or more of agreeableness, antagonistic, formal, informal, eccentricity, and stoicism. An example of category-score-indicating-text-segments for tone scoring of the agreeableness category includes, but is not limited to, “I agree,” “I must agree,” “I agree with the,” “I side with,” “I do not contest,” “I do not contend,” “I oblige,” and “I sympathize.”

Method 500 further includes determining 508 whether the dissent-identifying-index has been reached, and stopping 510 the tone scoring operation based on a determination that the dissent-identifying-index has been reached.

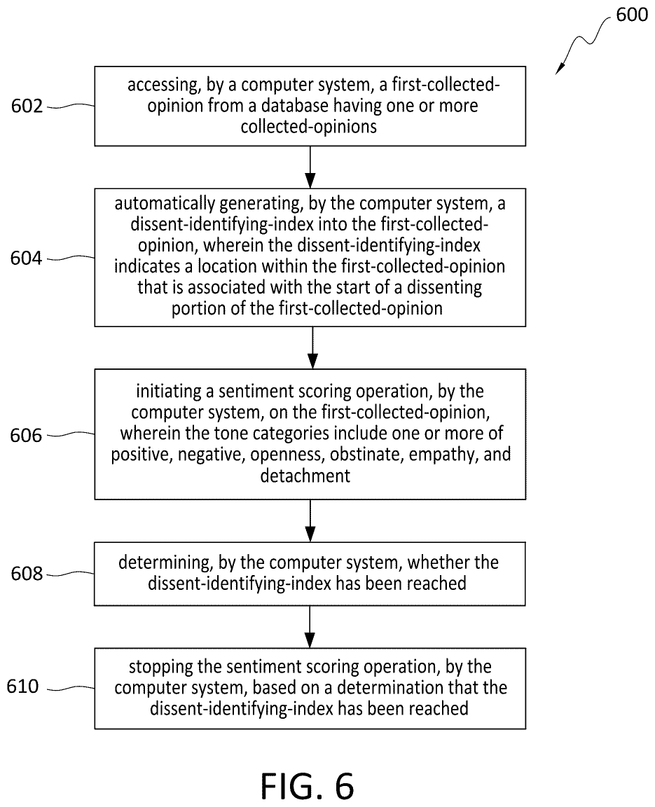

FIG. 6 is a flow diagram of an illustrative method 600 of sentiment scoring, in accordance with this disclosure. Method 600 is similar to method 400 and method 500 but differs in the categories that are evaluated. Method 600 includes accessing 602, by a computer system, a first-collected-opinion from a database having one or more collected-opinions. In various embodiments, prior to accessing the first-collected-opinion, one or more opinions are obtained from various sources of legal information, subjected to various text cleaning operations, subjected to various AI analyses, and stored to a data storage resource. Such a data storage resource may be co-located with the computer system or it may be cloud-based.

Method 600 continues by automatically generating 604, by the computer system, a dissent-identifying-index into the first-collected-opinion, wherein the dissent-identifying-index indicates a location within the first-collected-opinion that is associated with the start of a dissenting portion of the first-collected-opinion. Generating 604 the dissent-identifying-index may include performing one or more string searches of the first-collected-opinion to identify one or more strings that indicate the beginning of a dissent portion of the first-collected-opinion.

Still referring to FIG. 6, method 600 further includes initiating 606 the sentiment scoring operation on the first-collected-opinion, wherein the sentiment categories include one or more of positive, negative, openness, obstinate, empathy, and detachment. An example of category-score-indicating-text-segments for sentiment scoring of the positive category includes, but is not limited to, “Compelling argument,” “Sound reasoning,” “Admirable presentation,” “Thorough examination,” “Praiseworthy effort,” “Persuasive evidence,” “Convincing testimony,” and “Worthy of note.” These illustrative category-score-indicating-text-segments are not required to be case sensitive.

Method 600 further includes determining 608 whether the dissent-identifying-index has been reached, and stopping 610 the sentiment scoring operation based on a determination that the dissent-identifying-index has been reached.

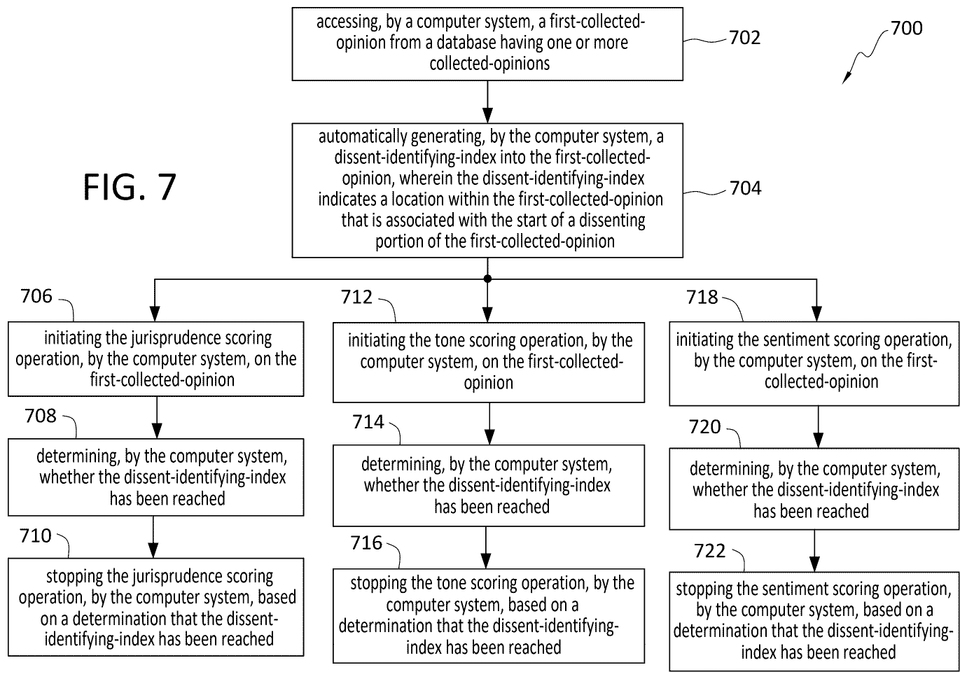

FIG. 7 is a flow diagram of one illustrative method 700 of performing jurisprudence scoring, tone scoring, and sentiment scoring in parallel, in accordance with this disclosure. Method 700 has certain similarities with method 400, 500, and 600, but performs those scoring operations in parallel. Parallel execution may be performed in number of ways including, but not limited to, the use of physical multi-processor systems, or virtualized multi-processor systems. Method 700 includes accessing 702, by a computer system, a first-collected-opinion from a database having one or more collected-opinions, and automatically generating 704, by the computer system, a dissent-identifying-index into the first-collected-opinion, wherein the dissent-identifying-index indicates a location within the first-collected-opinion that is associated with the start of a dissenting portion of the first-collected-opinion. In method 700, accessing 702 and generating 704 are common to jurisprudence scoring, tone scoring, and sentiment scoring. In accordance with method 700, jurisprudence scoring, tone scoring, and sentiment scoring may proceed in parallel. In some embodiments, each one of the parallel execution paths may have a private copy of the text that is to be scored, for example in a local cache memory. In alternative embodiments, each one of the parallel execution paths may have shared access to the text that is to be scored, for example a shared cache or shared access to the main memory of the computer system.

In some embodiments, method 700 includes operating a first execution path that performs initiating 702 the jurisprudence scoring operation on the first-collected-opinion, determining 708 whether the dissent-identifying-index has been reached, and stopping 710 the jurisprudence scoring operation, by the first execution path of the computer system, based on a determination that the dissent-identifying-index has been reached. Method 700 may further include operating a second execution path, in parallel with the first execution path, that performs initiating 712 the tone scoring operation, on the first-collected-opinion, determining 714 whether the dissent-identifying-index has been reached, and stopping 716 the tone scoring operation, by the second execution path of the computer system, based on a determination that the dissent-identifying-index has been reached. Method 700 may further include operating a third execution path in parallel with the first and second execution paths. The third execution path performs initiating 718 the sentiment scoring operation on the first-collected-opinion, determining 720 whether the dissent-identifying-index has been reached, and stopping 722 the sentiment scoring operation, by the third execution path of the computer system, based on a determination that the dissent-identifying-index has been reached.

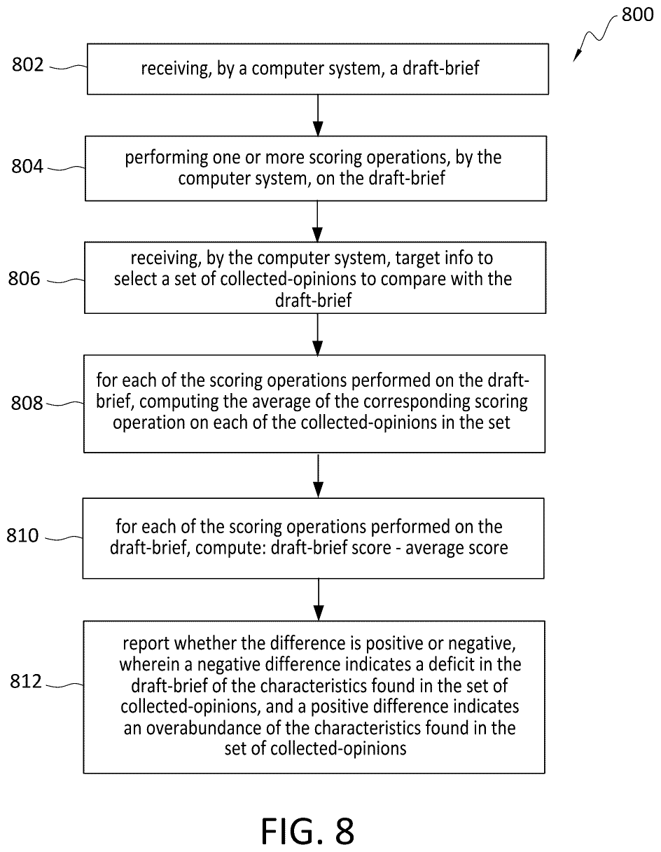

FIG. 8 is a flow diagram of an illustrative method 800 of brief scoring, in accordance with this disclosure. Method 800 includes receiving 802, by a computer system, a draft-brief, and performing 804 one or more scoring operations on the draft-brief. Such scoring operations (as described above) may include, but are not limited to, one or more of jurisprudence scoring, tone scoring, and sentiment scoring. Method 800 further includes receiving 806, by the computer system, target information to select a set of collected-opinions to compare with the draft-brief. The target information may specify one or more courts and/or one or more judges. Method 800 obtains the collected-opinions from data storage that satisfy the conditions of the target information along with the associated scoring and biographical information of those collected-opinions. For each of the scoring operations performed on the draft-brief, computing 808 the average of the corresponding scoring operation on each of the collected-opinions in the set. Method 800 continues by computing 810 the value of (draft-brief score-average score) for each of the scoring operations performed on the draft-brief. Method 800 further includes reporting 812 whether the difference is positive or negative. If the difference is negative, there is a deficit and method 800 provides sample quotes pulled from the judge/court as examples of things to reference as good examples of what to add to the brief. If the difference is positive, there is an overkill and method 800 submits the brief to an AI service to find examples of the category that is in overkill. These quotes are returned to the user as examples of language that might need to be removed or reworked.

In some embodiments, in accordance with this disclosure, a re-write feature is provided as a tool within the re-write system. In some embodiments, the re-write system is implemented by non-transitory computer instructions that are stored in the memory of a computer system, which when executed by the computer system cause the methods of the re-write system to be performed.

The re-write system allows a user to re-draft up to a pre-determined number of words at a time by using a large language model (LLM) within an embodiment. Alternatively, various embodiments may access an externally-provided LLM rather than having an LLM within the re-write system. An illustrative use case is for users to upload a brief, and receive recommendations regarding possible revisions to the brief to make that brief more persuasive to the target audience of the brief. Thus, in accordance with this disclosure, the illustrative use case may include identifying portions of text in the brief that may that may be unhelpful toward the goal of persuading the judge(s) handling their case, and to improve those portions of text using the re-write tool. Further, the re-write tool may be used in combination with other analytics about the judge(s) and their language preferences.

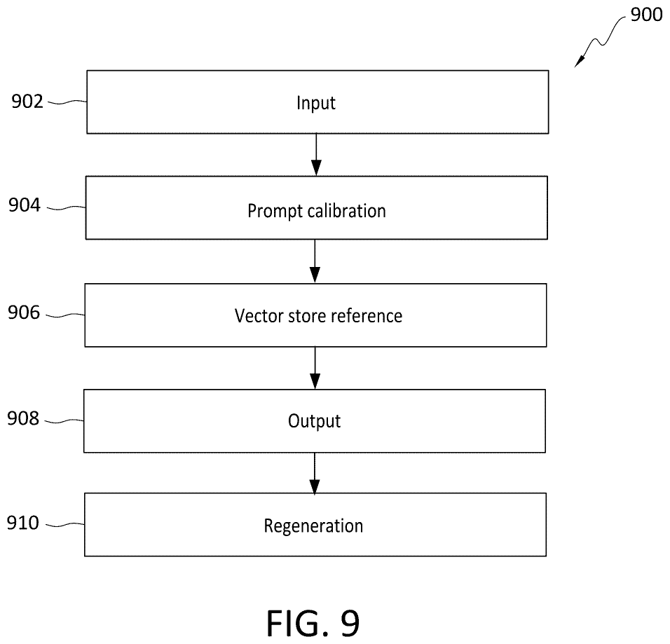

FIG. 9 is a flow diagram of an illustrative method 900 of re-writing a portion of a brief, in accordance with this disclosure. Method 900 includes an input operation 902. In some embodiments, input operation 902 includes providing a text box on a display device/user interface, by the re-write system. Text entered into the text box may be received and processed by the re-write system. In some embodiments, the text entered into the text box corresponds to at least a portion of the text from a brief that is to be processed. The text to be processed may also be referred to as the user's “input language.” Method 900, in accordance with this disclosure, may identify some or all of the user's input language, as failing to be within a predetermined persuasiveness space. That is, some or all of the user's input language may be susceptible of improvement with respect to persuading a particular target audience based on predetermined knowledge of the target audience's demonstrated preferences, i.e., likes and dislikes, for persuasive argument styles and approaches.

Method 900 may further include a prompt calibration 904 operation. A prompt calibration 904 operation, in accordance with this disclosure, may be used to “fine tune” the recommendations that the re-write feature will generate. To perform a prompt calibration 904 operation, the user selects the manner in which their input language will be altered. For example, by making their input language more or less of a selected subcategory type (e.g., textualist, negative, antagonistic, and so on). These selections influence the generation of a prompt that is used to guide the LLM in producing an output. The output in this instance being replacement-language to replace the identified input language The prompt is partly pre-designed to produce high-quality outputs, but the user's help in calibrating the prompt for their desires adds additional direction to the models.

The calibrated prompt is then used by the LLM, which references 906 a vector store containing one or more language algorithms that may be used to influence the LLM output 908. As noted above, and in accordance with method 900, the LLM produces an replacement-language as an output that may be used to revise, typically by replacement, the identified input language. The goal of revising the identified input language is to change the framing of the arguments provided in the input language without changing their substance.

In some embodiments, the re-write system may receive an instruction from the user to regenerate 910 an LLM output, i.e., re-running the model with the same or similar prompt, which in turn may generate an output (replacement-language in this example) that is different than its previous output. Alternatively, in some embodiments, the user can regenerate the LLM output but with feedback provided to the re-write system prior to re-running the model. In some embodiments, the re-write system receives feedback from information input via a dropdown list, and/or information entered into a text box, where the information received from the dropdown list and/or the text box indicate things about the previous output that were disliked by the user.

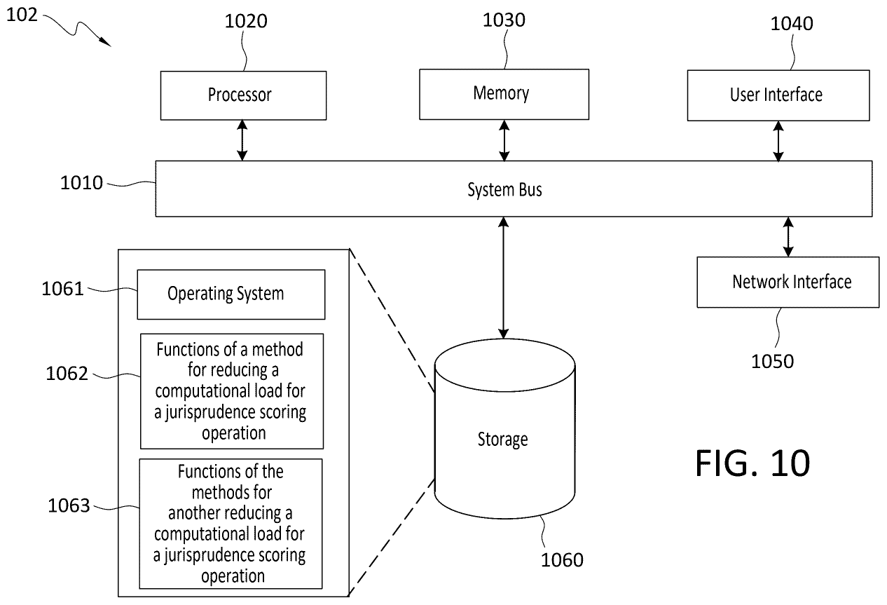

FIG. 10 shows an illustrative hardware diagram of a computer system 102 for implementing at least portions of various embodiments described herein. As shown, system 102 includes a processor 1020, a memory 1030, a user interface 1040, a network interface 1050, and a storage subsystem 1060 communicatively coupled via one or more system buses 1010. It will be understood that FIG. 10 constitutes, in some respects, an abstraction and that the actual organization of the components of computer system 102 may be more complex than illustrated.

Processor 1020 may be any hardware device capable of executing instructions stored in memory 1030 or storage subsystem 1060, or otherwise processing data. As such, processor 1020 may include a microprocessor, microcontroller, graphics processing unit (GPU), digital signal processor (DSP), vector processor, neural network processor, artificial intelligence accelerator, deep learning processor, field programmable gate array (FPGA), application-specific integrated circuit (ASIC), or other similar devices or combination of devices.

Memory 1030 may include various memories such as, for example L1, L2, or L3 cache or system memory. As such, memory 1030 may include static random-access memory (SRAM), dynamic RAM (DRAM), non-volatile memory (e.g., flash memory), read only memory (ROM), or other similar memory devices, or various combinations of some or all of the foregoing memory types.

User interface 1040 may include one or more devices for enabling communication with a user. For example, user interface 1040 may include a display, a touch interface, a voice interface, a mouse, and/or a keyboard for receiving user commands. In some embodiments, user interface 1040 may include a command line interface or graphical user interface that may be presented to a remote terminal via network interface 1050.

Network interface 1050 may include one or more devices for enabling communication with other hardware devices. For example, network interface 1050 may include a network interface card (NIC) configured to communicate according to the Ethernet protocol or other communications protocols, including wireless protocols. Additionally, network interface 1050 may implement a TCP/IP stack for communication according to the TCP/IP protocols. Various alternative or additional hardware or configurations for network interface 1050 will be apparent.

Storage subsystem 1060 may include one or more machine-readable storage media such as read-only memory (ROM), random-access memory (RAM), magnetic disk storage media, optical storage media, flash-memory devices, or similar storage media. In various embodiments, storage subsystem 1060 may store instructions for execution by processor 1020 or data upon which processor 1020 may operate. For example, storage subsystem 1060 may store a base operating system 1061 for controlling various basic operations of computer system 102. Storage subsystem 1060 may include storage 1062 that includes software that when executed implements the functions of the methods of reducing a computational load for a jurisprudence scoring operation. Storage subsystem 1060 may further include storage 1063 that includes software that when executed implements the functions for an alternative method of reducing a computational load for a jurisprudence scoring operation.

Memory 1030 and storage subsystem 1060 may both be considered to be “non-transitory machine-readable media.” As used herein, the term “non-transitory” will be understood to exclude transitory signals but to include all forms of storage, including both volatile and non-volatile memories.

System bus 1010 allows communication between processor 1020, memory 1030, user interface 1040, storage subsystem 1060, and network interface 1050.

Computer system 102 is shown as including one of each described component, however, the various components may be duplicated in various embodiments. For example, processor 1020 may include multiple microprocessors that are configured to independently execute the methods described herein or are configured to perform steps or subroutines of the methods described herein such that the multiple processors cooperate to achieve the functionality described herein. Further, where computer system 102 is implemented in a cloud computing system, the various hardware components may belong to separate physical systems. For example, processor 1020 may include a first processor in a first server and a second processor in a second server.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

Since numerous changes and modifications can be made in all of the above-described details without departing from the spirit and nature of the disclosure. It is to be understood that all such changes and modifications are included within the scope of the disclosure.

It is expected that others will perceive differences, which, while differing from the forgoing, do not depart from the scope of the disclosure herein described and claimed. In particular, any of the functional elements described herein may be replaced by any other known element having an equivalent function.

A variety of programming languages and software may also be used, individually or in concert, to achieve the results in different embodiments. Natural language processing, sentiment analysis, and other forms of machine learning/artificial intelligence might be used in different embodiments. As used herein, the term “nominal/nominally” refers to a desired, or target, value of a characteristic or parameter for a component or a process operation, set during the design phase of a product or a process, together with a range of values above and/or below the desired value. The range of values can be due to slight variations in manufacturing processes or tolerances.

As used herein, the term “about” indicates the value of a given quantity may vary from its nominal value based on, for example, various manufacturing tolerances. By way of example, and not limitation, the term “about” may indicate the cited value of a given quantity may vary within, for example, 1-30% of the value (e.g., ±0.5%, ±1%, ±5%, ±10%, ±20%, or ±30% of the value). Specific ranges are provided herein when needed.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the subjacent claims.

What is claimed is:

1. A method of reducing a computational load for a jurisprudence scoring operation, comprising:
accessing, by a computer system, a first-collected-opinion from a database having one or more collected-opinions, wherein the first-collected-opinion comprises text and includes at least a non-dissenting portion and a dissenting portion;
automatically generating, by the computer system, a dissent-identifying-index into the first-collected-opinion, wherein the dissent-identifying-index indicates a location within the first-collected-opinion that is associated with the start of the dissenting portion of the first-collected-opinion;
initiating the jurisprudence scoring operation, by the computer system, on the first-collected-opinion;
determining, by the computer system, whether the dissent-identifying-index has been reached; and
stopping the jurisprudence scoring operation, by the computer system, based on a determination that the dissent-identifying-index has been reached.

2. The method of claim 1, further comprising:
initiating a tone scoring operation, by the computer system, on the first-collected-opinion; and
initiating a sentiment scoring operation, by the computer system, on the first-collected-opinion.

3. The method of claim 2, wherein automatically generating a dissent-identifying-index into the first-collected-opinion comprises:
providing a dissent-list, wherein the dissent-list includes a pre-determined set of dissent-indicating-text-segments;
performing a first set of text matching operations, comprising:
comparing at least a portion of the set of the dissent-indicating text-segments to the text of the first-collected-opinion, identifying a location within the first-collected-opinion at which each text match occurs, and storing at least a portion of the identified locations;
selecting a first one of the identified locations to be the dissent-identifying-index; and
storing the dissent-identifying-index.

4. The method of claim 3, wherein the jurisprudence scoring operation comprises:
providing a category-list, wherein the category-list includes a plurality of categories;
providing for each category of the plurality of categories, a corresponding set of category-score-indicating-text-segments;
performing a second set of text matching operations, comprising:
comparing at least a portion of each of the sets of category-score-indicating-text-segments to the non-dissenting portion of the first-collected-opinion, and
counting the occurrences of text matches between each of the sets of category-score-indicating-text-segments and the non-dissenting portion of the first-collected-opinion, and storing a count of the occurrences for each of the sets of category-score-indicating-text-segments as a raw-score for each corresponding category;
adding the raw-scores to generate a total count;
providing, for each category of the plurality of categories, a corresponding predetermined scale factor; and
scaling each raw score by its corresponding predetermined scale factor,
wherein the category-list comprises at least one of a first term representing textualism, a second term representing traditionalism, a third term representing precedent, a fourth term representing policy, a fifth term representing purposivism, and a sixth term representing originalism.

5. The method of claim 4, wherein scaling the raw score for each corresponding category comprises:
performing a floating point multiplication between at least a first raw-score and a corresponding predetermined scale factor to generate a first scaled score.

6. The method of claim 5, further comprising:
performing a floating point division of at least the first scaled score by 100; and
rounding a result of the floating point division.

7. The method of claim 1, wherein accessing the first-collected-opinion from the database having one or more collected-opinions comprises:
receiving at least one date range for an adjustable time filter; and
prohibiting access to collected-opinions having dates that are outside the at least one date range.

8. The method of claim 3, wherein the dissent-list comprises one or more of the phrases:
“I dissent,”
“It is so ordered,”
“The judgment of the Court of Appeals is reversed, and the case is remanded for further proceedings consistent with this opinion,”
“join, dissenting,”
“requiring this respectful dissent,”
“It is so ordered,” and
“Judgment reversed”.

9. The method of claim 4, wherein the set of category-score-indicating-text-segments for the textualist category comprises one or more of the phrases:
“plain text,”
“statutory text,”
“plain term,”
“plain terms,”
“ordinary meaning,”
“plain meaning,”
“natural meaning,” and
“ordinary reading”.

10. The method of claim 4, further comprising:
modifying, by the computer system, at least one predetermined scale factor responsive to an input received by the computer system.

11. A method of reducing a computational load for a scoring operation, comprising:
receiving, by a computer system, at least one date range for an adjustable time filter;
accessing, by the computer system, a first-collected-opinion from a data storage resource having one or more collected-opinions, wherein the first-collected-opinion comprises text and includes at least a non-dissenting portion and a dissenting portion;
automatically generating, by the computer system, a dissent-identifying-index into the first-collected-opinion, wherein the dissent-identifying-index indicates a location within the first-collected-opinion that is associated with the start of a dissenting portion of the first-collected-opinion;
generating a workload-reduced-first-collected-opinion from the first-collected-opinion, wherein the workload-reduced-first-collected-opinion does not include the dissenting portion of the first-collected-opinion; and
initiating the scoring operation on the workload-reduced-first-collected-opinion,
wherein accessing the first-collected-opinion from the data storage resource having one or more collected-opinions includes prohibiting access to collected-opinions having dates that are outside the at least one date range of the adjustable time filter.

12. The method of claim 11, further comprising storing the workload-reduced-first-collected-opinion to the data storage resource.

13. The method of claim 11, further comprising:
providing a category-list, wherein the category-list includes a plurality of categories; and
providing for each category of the plurality of categories, a corresponding set of category-score-indicating-text-segments.

14. The method of claim 13, wherein the category-list comprises at least one of a first term representing textualism, a second term representing traditionalism, a third term representing precedent, a fourth term representing policy, a fifth term representing purposivism, and a sixth term representing originalism.

15. The method of claim 13, wherein the category-list comprises at least one of a first term representing agreeableness, a second term representing antagonistic, a third term representing formal, a fourth term representing informal, a fifth term representing eccentricity, and a sixth term representing stoicism.

16. The method of claim 13, wherein the category-list comprises at least one of a first term representing positive, a second term representing negative, a third term representing openess, a fourth term representing obstinance, a fifth term representing empathy, and a sixth term representing detachment.

17. A system for reducing the computational load of analyzing legal documents, comprising:
a non-transitory memory having computer instructions stored therein that when executed by a computer system cause the computer system to:
access a first-collected-opinion from a database having one or more collected-opinions, wherein the first-collected-opinion comprises text and includes at least a non-dissenting portion and a dissenting portion;
automatically generate a dissent-identifying-index into the first-collected-opinion, wherein the dissent-identifying-index indicates a location within the first-collected-opinion that is associated with the start of the dissenting portion of the first-collected-opinion;
initiate a scoring operation on the first-collected-opinion;
determine whether the dissent-identifying-index has been reached; and
stop the scoring operation based on a determination that the dissent-identifying-index has been reached.

18. The system of claim 17, wherein the scoring operation comprises one or more of jurisprudence scoring, tone scoring, and sentiment scoring.

19. The system of claim 18, wherein the non-transitory memory has further computer instructions stored therein that when executed by the computer system cause the computer system to:
provide a category-list, wherein the category-list includes a plurality of categories;
provide for each category of the plurality of categories, a corresponding set of category-score-indicating-text-segments;
perform a set of text matching operations, comprising:
comparing at least a portion of each of the sets of category-score-indicating-text-segments to the non-dissenting portion of the first-collected-opinion, and
counting the occurrences of text matches between each of the sets of category-score-indicating-text-segments and the non-dissenting portion of the first-collected-opinion, and storing a count of the occurrences for each of the sets of category-score-indicating-text-segments as a raw-score for each corresponding category;
add the raw-scores to generate a total count;
provide, for each category of the plurality of categories, a corresponding predetermined scale factor; and
scale each raw score by its corresponding predetermined scale factor.

20. The system of claim 17, wherein the category-list comprises at least one of a first term representing textualism, a second term representing traditionalism, a third term representing precedent, a fourth term representing policy, a fifth term representing purposivism, and a sixth term representing originalism.

21. The system of claim 17, wherein the system further comprises an adjustable time filter.
